(19) United States
(12) Patent Application Publication
(10) Pub. No.: US 2010/0245598 A1
(43) Pub. Date: Sep. 30, 2010

(54) IMAGE COMPOSING APPARATUS AND COMPUTER READABLE RECORDING MEDIUM

(75) Inventor: Akira HAMADA, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/749,733

(22) Filed: Mar. 30, 2010

(30) Foreign Application Priority Data
Mar. 31, 2009 (JP) 2009-085908

(51) Int. Cl. G06K 9/48; H04N 5/228; H04N 5/225

(52) U.S. Cl. 348/207.11; 348/222.1; 382/199; 348/E05.031; 348/E05.024

(57) ABSTRACT

Group photographs are continuously taken with the same background, whereby at least two image frames are produced. A position of a face of each person is detected from each image frame. A combination weighting function w[p](x, y) is set such that, on the basis of the face detected in one of the two image frames, combination weights of pixels of the said one image frame to corresponding pixels of the other image frame are set, which combination weights decrease with increasing distance from the face of the person in said one image frame. The pixels of the said one image frame are laid on the corresponding pixels of the other image frame based on the combination weighting function w[p](x, y), whereby one composed image is produced.

### CROSS REFERENCE TO RELATED APPLICATIONS

The present application is based on and claims the benefit of priority from the prior Japanese Patent Application No. 2009-085908, filed on Mar. 31, 2009, and including specification, claims, drawings and summary, the entire contents of which are incorporated herein by reference.

### BACKGROUND OF THE INVENTION

1. Field of the Invention

The present invention relates to an image composing apparatus, which combines plural images to produce a composed image, and to a computer readable recording medium.

2. Description of the Related Art

It is not easy to take a group photograph, while all the members keep unblinking and smiling. Even if photographs are continuously shot to obtain plural pictures, it is hard to obtain a picture, which all the members completely satisfy with. A technique is known, which allows each member to choose a picture he or she likes from among the plural pictures obtained by the continuous shooting, and combines the chosen pictures into one composed picture.

Meanwhile, a method is also known, which selects or extracts an area of a individual and/or selects a proper image frame in response to user's input operation, and combines the selected areas and/or image frames. In the method, the shape of the extracted area of the individual is express by outlines of a human face or whole body presumed by edges detected in the neighborhood of points designated by a user. Unconformity caused in combining images is compensated by blurring the edges of the extracted outlines.

However, it is hard to obtain robust outlines of a person by detecting edges, and in particular, it is essentially impossible to obtain outlines of a person standing in complex scenery in the background or outlines of a person overlapping with other person by detecting edges of the person. Therefore, the outlines of objects other than a person are cut off, inviting unnatural and wrong result. The edge blurring process is executed on a local portion, and therefore cannot compensate for unconformity spreading over a wide area. Not in need of blur, the edge blurring process can be a cause of degrading sharpness, losing image quality.

A technique is known, which automatically select the most proper image frame of each person, and combines the selected image frames only with an eye portion of the person replaced. In the technique, replacement of related portions is effected within a face area of the person, and therefore unconformity does not cause any trouble in background and/or in body portion other than the face. But it is not robust in detecting an eye portion compared with detecting a face portion. Therefore, there can be error in calculating a position of eye, casing an extreme unconformity in a worst case. When a person has imperceptibly turned his or her face while taking a picture, there is a problem that replacement of an eye portion can cause an unnatural and wrong result.

Further, a method is known, which uses Graph Cuts for calculating an appropriate segmentation boundary as an arbitrary contour. In the method, ideal results are output in many cases, but there is a problem that invites an extremely unnatural and wrong result that a portion of a body is lost and/or bodies are combined. In many cases, the user can solve the problem in an interactive process, using marking compensation. But the user is required to use an input device such as a mouse and stylus pen, increasing costs of an apparatus and requiring user's troublesome and time consuming manipulation.

### SUMMARY OF THE INVENTION

According to aspects of the present invention, there are provided an image composing apparatus, which combines plural images to produce a composed image in a simple and proper manner, and a computer readable recording medium.

According to one aspect of the invention, there is provided an image composing apparatus, which comprises an image pick-up unit for continuously taking group photographs with the same background to produce at least two images, wherein the group photograph includes plural persons, a feature detecting unit for detecting a position of a feature portion of each person included in the group photograph from each of the two images produced by the image pick-up unit, a weight setting unit for, on the basis of the position of the feature portion in one of the two images detected by the feature detecting unit, setting combination weights of pixels of said one image to corresponding pixels of the other image, which combination weights decrease with increasing distance from the position of the feature portion in said one image, and an image composing unit for overlaying the pixels of said one image on the corresponding pixels of the other image in accordance with the combination weights of said one image set by the weight setting unit to produce a composed image.

According to another aspect of the invention, there is provided a computer readable recording medium to be mounted on an image composing apparatus, wherein the image composing apparatus is provided with a computer and an image pick-up unit for continuously taking group photographs with the same background to produce at least two images, wherein the group photograph includes plural persons, the recording medium having recorded thereon a computer program when executed to make the computer function as means, which comprises a feature detecting means for detecting a position of a feature portion of each person included in the group photograph from each of the two images produced by the image pick-up unit, a weight setting means for, on the basis of the position of the feature portion in one of the two images detected by the feature detecting means, setting combination weights of pixels of said one image to corresponding pixels of the other image, which combination weights decrease with increasing distance from the position of the feature portion in said one image, and an image composing means for overlaying the pixels of said one image on the corresponding pixels of the other image in accordance with the combination weights of said one image set by the weight setting means to produce a composed image.

### BRIEF DESCRIPTION OF THE DRAWINGS

These aspects and other aspects and advantages of the present invention will become more apparent upon reading of the following detailed description and the accompanying drawings in which:

FIG. 1 is a block diagram showing a configuration of an embodiment of an image pick-up apparatus, in which the present invention is applied.

FIG. 2 is a flow chart showing one example of the composed image producing process to be performed in the image pick-up apparatus shown in FIG. 1.

FIGS. 3A and 3B are views schematically showing original image frames used in the composed image producing process of FIG. 2.

FIG. 4 is a view schematically showing a composed image produced in the composed image producing process of FIG. 2.

### DETAILED DESCRIPTION OF THE PREFERRED EMBODIMENTS

Now, the present invention will be described in detail with reference to the accompanying drawings. But the scope of the invention is by no means limited to embodiments shown by way of example in the drawings.

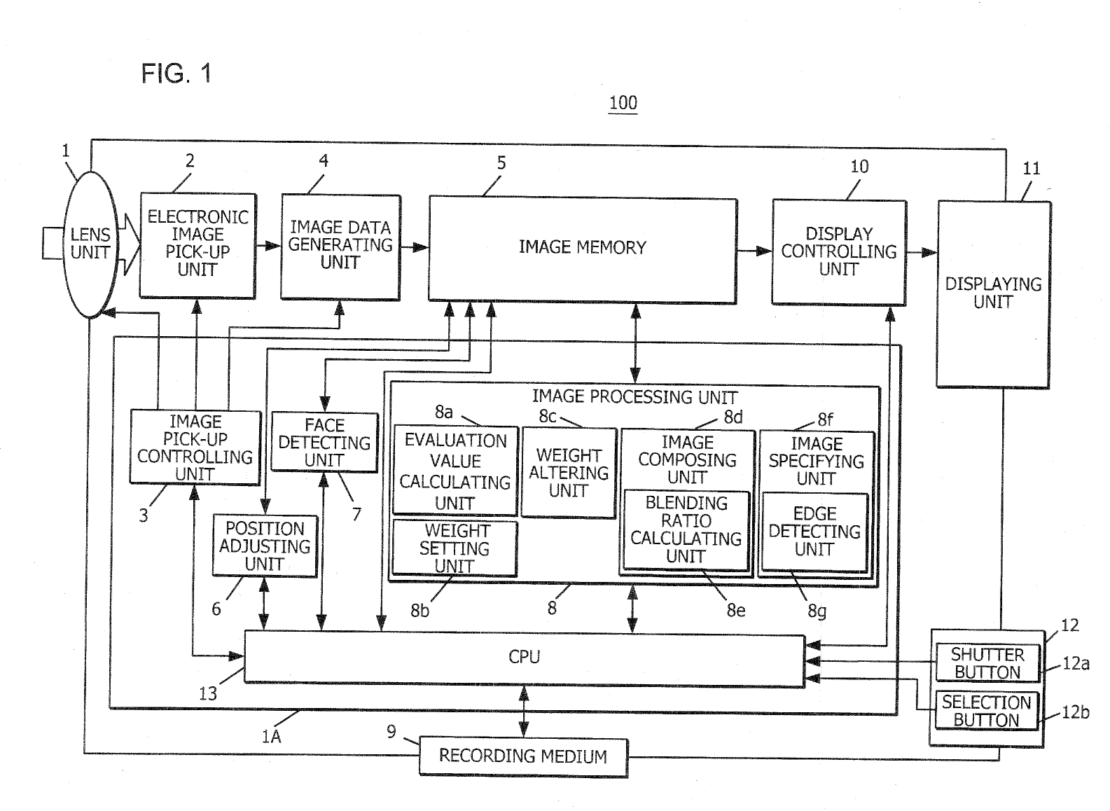

FIG. 1 is a block diagram showing a configuration of an embodiment of an image pick-up apparatus 100, in which the present invention is applied.

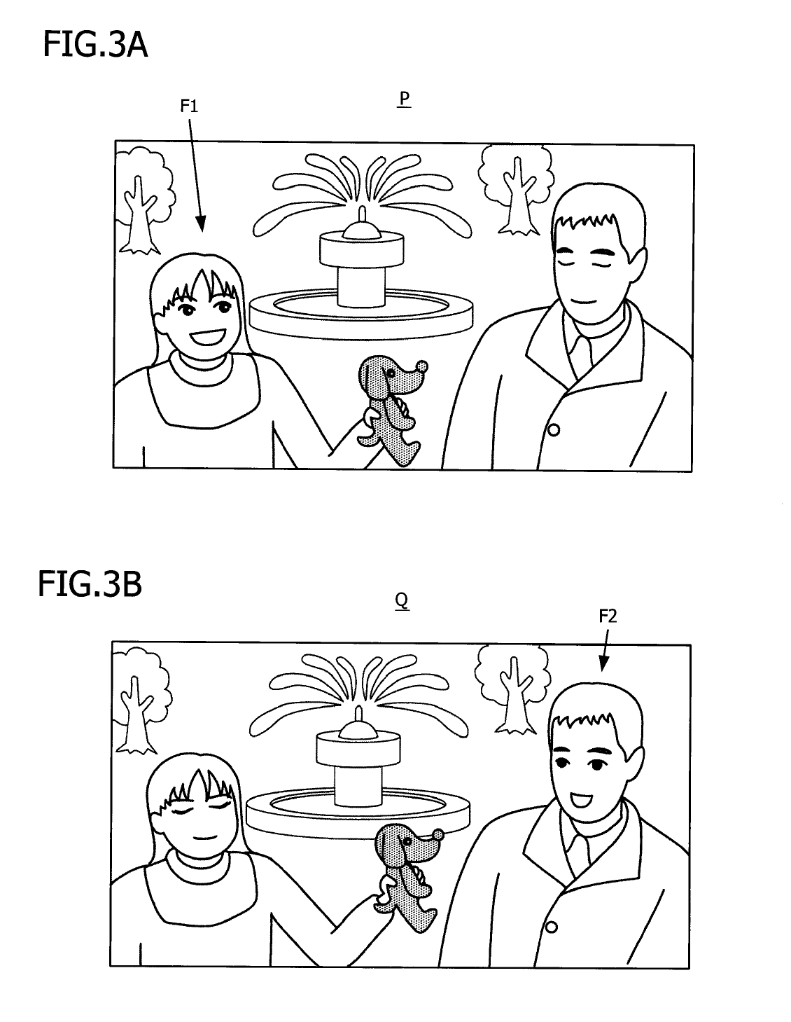

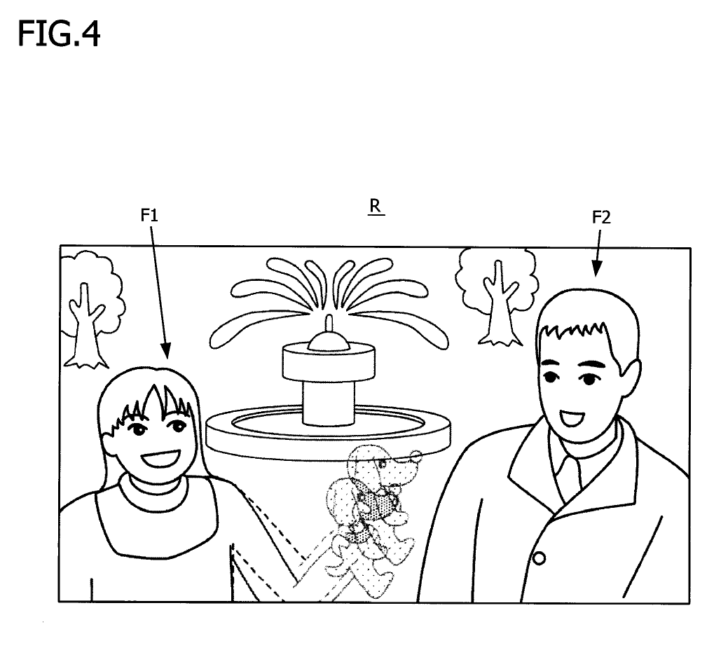

In the image pick-up apparatus 100 according to the embodiment of the invention, a combination weighting function w[p](x, y) is set, such that, on the basis of a human face F1 seen in one (for example, an image frame “P”) of at least two image frames (for example, an image frame “P” shown in FIG. 3A and an image frame “Q” shown in FIG. 3B), combination weights of pixels of the one image frame (image frame “P”) to the corresponding pixels of the other image frame (image frame “Q”) are given, which decrease with increasing distance from the human face F1 in the one image frame (image frame “P”). And based on the combination weighting function w[p](x, y) of the one image frame (image frame “P”), the pixels of one image frame (image frame “P”) are overlaid on the corresponding pixels of the other image frame (image frame “Q”) to produce a composed image “R” as shown in FIG. 4.

More specifically, as shown in FIG. 1, the image pick-up apparatus 100 comprises a lens unit 1, electronic image pick-up unit 2, image pick-up controlling unit 3, image data generating unit 4, image memory 5, position adjusting unit 6, face detecting unit 7, image processing unit 8, recording medium 9, display controlling unit 10, displaying unit 11, operation input unit 12 and CPU 13.

The mage pick-up controlling unit 3, position adjusting unit 6, face detecting unit 7, image processing unit 8 and CPU 13 are integrated, for example, into a custom LSI 1A.

The lens unit 1 has plural lenses including zoom lenses and focus lenses.

Further, the lens unit 1 may be provided with a zoom lens driving unit (not shown) for moving the zoom lenses along an optical axis and a focus lens driving unit (not shown) for moving the focus lenses along the optical axis when shooting an object.

The electronic image pick-up unit 2 consists of an image sensor such as CCD (Charge Coupled Device) and CMOS (Complementary Metal-Oxide Semiconductor), and converts an optical image passing through various lenses in the lens unit 1 into a two dimensional image signal.

The mage pick-up controlling unit 3 is provided with a timing generator (not shown) and driver (not shown). The mage pick-up controlling unit 3 makes the timing generator and the driver scan the electronic image pick-up unit 2 to convert an optical image into a two dimensional image signal every predetermined period, thereby reading and outputting an image frame for one image from an image pick-up area of the electronic image pick-up unit 2 to the image data generating unit 4.

Further, the mage pick-up controlling unit 3 adjusts shooting conditions for AF (Automatic Focusing process), AE (Automatic Exposure process) and AWB (Automatic White Balance process).

The lens unit 1, the electronic image pick-up unit 2 and the mage pick-up controlling unit 3 constructed as described above serve as image pick-up means to continuously shoot an object at a predetermined frame rate (“continuous shooting operation”), thereby producing plural image frames.

The image data generating unit 4 performs a gain adjustment on R, G, and B color components included in an analog signal of image frame transferred from the electronic image pick-up unit 2. The gain adjusted color components are subjected to a sample holding process at a sample hold circuit (not shown) and then converted into a digital signal at A/D converter (not shown). Then, the digital signal is subjected to a color processing including a pixel interpolation process and gamma correction at a color processing circuit (not shown), whereby a digital luminance signal “Y” and digital color-difference signals Cb, Cr (YUV data) are generated. The luminance signal “Y” and color-difference signals Cb, Cr output from the color processing circuit are transferred to the image memory 5 through DMA controller (not shown) by means of DMA system. The image memory 5 is used as a buffer memory.

A de-mosaic processing unit (not shown) for developing digital data obtained by A/D conversion may be mounted into the custom LSI 1A.

The image memory 5 consists, for example, of DRAM and temporarily stores data. The data will be processed by the position adjusting unit 6, face detecting unit 7, image processing unit 8, and CPU 13.

The position adjusting unit 6 aligns positions of plural image frames continuously shot (that is, produced in the continuous shooting operation) by the image pick-up means. More particularly, the position adjusting unit 6 is provided with a feature value calculating unit (not shown), block matching unit (not shown) and a coordinate-transform equation calculating unit (not shown).

The feature value calculating unit serves to perform a feature extracting process. In the feature extracting process, on the basis of one (for example, image frame “P”) of adjacent image frames (for example, image frames “P” and “Q”) among plural image frames, feature points are extracted from the one image frame (image frame “P”). More particularly, the feature value calculating unit selects a predetermined number of block areas (feature points) (or not less than predetermined number of block areas) which contain prominent features, and extracts contents of the selected block areas to produce templates (for example, squares of 16×16 pixels).

The block matching unit serves to perform a block matching process to adjust positions of adjacent image frames. More particularly, the block matching unit searches for a portion of the other image frame which corresponds to the templates extracted and produced in the feature extracting process. In other words, the block matching unit searches for the portion (corresponding area) of the other image frame, which meets a pixel value of the template most appropriately. Further, the block matching unit calculates the most suitable offset or disagreement between the adjacent image frames, where the most appropriate evaluation value of differences in the pixel values (for example, Sum of Squared Differences (SSD) and Sum of Absolute Differences (SAD)) is given to obtain a motion vector of the template.

On the basis of the feature points extracted from the one image frame (image frame “P”) of the adjacent image frames (for example, the image frames “P” and “Q”), the coordinate-transform equation calculating unit calculates a coordinate-transform equation of each pixel of other image frame (image frame “Q”) to the one image frame (image frame “P”). In other words, the coordinate-transform equation calculating unit calculates motion vectors of the plural templates calculated by the block matching unit by majority decision, and uses the motion vector, which is judged to meet more than a predetermined percentages (for example, 50%) as the motion vector representing the whole of the image frame, thereby calculating a projection transform matrix of the other image frame (image frame “Q”) using the feature point correspondence concerning said motion vector. Then, the position adjusting unit 6 transforms the coordinate of the other image frame (image frame “Q”) in accordance with the calculated projection transform matrix, thereby bringing both the image frames (image frames “P” and “Q”) in position.

The face detecting unit 7 detects a human face from each of the plural image frames produced in the continuous shooting operation by the image pick-up means using a predetermined human face detecting method (for example, a face detecting device of VIOLA-JONES). In other words, on the assumption that a position of a face of an object (person) does not move significantly during the continuous shooting operation, based on YUV data of a typical image frame (for example, image frame “P”) selected out of the plural image frames temporarily stored in the image memory 5, the face detecting unit 7 detects a face image area from the typical image frame (image frame “P”) and obtains a position and size of the face as a frame (face frame) of the face image area in the typical image frame (image frame “P”). The face image area detected from the typical image frame (image frame “P”) is used to obtain a position and size of a face in an image frame (for example, image frame “Q”) other than the typical image frame (image frame “P”). As the position of the face are obtained the central coordinates (u[i], v[i]) of the face frame, and an average of longitudinal and horizontal lengths of the face frame is calculated to obtain the size s[i] of the face frame, where “i” is an index denoting a person.

Since a face detecting process is well known technique, detailed description thereof will be omitted herein.

The face detecting unit 7 serves as face detecting means for detecting a position of a human face from each of plural image frames. Further, the face detecting unit 7 serves as feature detecting means for detecting features of a human face in each image frame.

Since the above described face detecting method is one example, the face detecting method to be used in the invention is not limited to the above. To improve the success rate in detecting a face in an image frame, it may be possible to detect a face in every image frame but not in a single image frame and determine that the persons who have the faces detected respectively at the corresponding positions in the adjacent image frames are the same person. In the case that faces are not detected from adjacent image frames in a stable manner, a face detecting/combining process may be used, in which an existence of face in an image frame is determined by majority decision.

The image processing unit 8 is provided with an evaluation value calculating unit 8a for calculating an evaluation value of a face of each of image frames to be combined.

Using evaluation of a blinking rate of a human eye, evaluation of a smile on a face including narrowed eye look and look of mouth corner, and total evaluation of these evaluations, the evaluation value calculating unit 8a calculates an evaluation value, a less value of which is assigned. to a good looks, whereby an image frame can be obtained, which gives the least evaluation value of a person “i” (face frame) seen in the image frame. A frame index of the image frame is denoted by b[i].

Further, the image processing unit 8 is provided with a weight setting unit 8b for setting a combination weighting function w[p](x, y) of each image frame to other image frames to be combined with said image frame.

The weight setting unit 8b sets a center at a human face (for example, face “F1”) in an image frame (for example, image frame “P”), which includes a person “i” in a group photograph who shows the least face evaluation value. Further, the weight setting unit 8b sets combination weights of the pixels of the image frame (image frame “P”) to the corresponding pixels of the other image frame (for example, image frame “Q”), which decrease with increasing distance from the face F1 in the image frame “P”. In other words, the combination weighting function w[p](x, y) is set so as to continuously come close to “0” as each pixel (x, y) increases distance from the center of the face F1 in the image frame “P”. More specifically, the weight setting unit 8b defines the combination weighting function w[p](x, y) by Gaussian function expressed in the following equation (1). And the weight setting unit 8b decides the combination weighting function w[p](x, y) for each pixel (x, y) of each image frame “p” with respect to every person “i” of p=b[i] in each image frame “p” in accordance with the following equation (2).

$$\begin{matrix}f [ i ] ( x , y ) = exp ( - \frac{{( u [ i ] - x )}^{2} + {( v [ i ] - y )}^{2}}{2 {σ [ i ]}^{2}} ) & ( 1 ) \\ w [ p ] ( x , y ) = {max}_{i ∈ \{ i \vert p = b [ i ] \}} f [ i ] ( x , y ) & ( 2 )\end{matrix}$$

where σ[i] is a parameter, and as its initial value is set a product of the size s[i] of the face frame and a proper constant, that is, a value proportional to the size s[i] of the face frame is set as the initial value of the parameter σ[i]. In the equation (2), “max” can be replaced with “sigma” Σ.

Gaussian function as expressed by the equation (1) requires more computational efforts and is hard to deal with because of its threshold magnitude. Therefore, the following polynomial equations (3) and (4) can be used in place of the equation (1).

$$\begin{matrix}f [ i ] ( x , y ) = \frac{1}{1 + \frac{{( u [ i ] - x )}^{2} + {( v [ i ] - y )}^{2}}{2 {σ [ i ]}^{2}}} & ( 3 ) \\ f [ i ] ( x , y ) = \frac{1}{1 + \frac{{( u [ i ] - x )}^{4} + {( v [ i ] - y )}^{4}}{2 {σ [ i ]}^{4}}} & ( 4 )\end{matrix}$$

The weight setting unit 8b serves as weight setting means for setting the combination weighting function w[p](x, y), which sets combination weights of the pixels of the image frame “P” (or image frame “Q”) to the corresponding pixels of the image frame “Q” (or image frame “P”). More specifically, on the basis of the human face (feature point) F1 (or human face F2) in one (image frame “P”) (or image frame “Q”) of at least two image frames “P” and “Q” among plural image frames produced during the continuous shooting operation, the combination weights of the pixels of the image frame “P” (or image frame “Q”) to the corresponding pixels of the image frame “Q” (or image frame “P”) are set, which decrease with increasing distance from the human face F1 in the image frame “P” (or from the human face F2 in the image frame “Q”).

Further, the image processing unit 8 is provided with a weight altering unit 8c for altering the parameter σ[i] of the combination weighting function w[p](x, y) set by the weight setting unit 8b.

The weight altering unit 8c alters the parameter σ[i] in response to user's operation on the operation input unit 12 or automatically alters the parameter σ[i]. In other words, a scale of the parameter σ[i] is adjusted, whereby an area where weights given by the combination weighting function w[p](x, y) set by the weight setting unit 8b are balanced is altered, that is, a size of a portion of each image frame to be mixed or blended with other is altered.

For example, the weight altering unit 8c alters the scale of the parameter σ[i] to increase or decrease σ value in accordance with a predetermined control instruction signal input in response to user's operation on the operation input unit 12 in a manual weight altering mode. The σ value may be scaled evenly through the parameter σ[i] by multiplying said value by a proportional constant (single loop), or may be individually scaled every person “i”. In this case, σ[i] adjustment loop is contained in an individual selection loop (double loop).

Further, the weight altering unit 8c automatically alters the scale of σ value from a small value to a large value (for example, 0.5 to 1.5).

The image processing unit 8 is provided with an image composing unit 8d for overlaying every pixel of the image frame “P” on the corresponding pixel of the image frame “Q” to produce a composed image. The image composing unit 8d has a blending ratio calculating unit 8e for calculating an Alpha-value, or a blending ratio, at which each pixel of the image frame “P” is blended with the corresponding pixel of the image frame “Q” based on the combination weighting function w[p](x, y), using the following equation (5).

$$α [ p ] [ x , y ] = \frac{w [ p ] ( x , y )}{{\sum }_{q ∈ U} w [ q ] ( x , y )} \qquad ( 5 )$$

where U denotes a class of whole frame indexes.

The Alpha-value (0 “α” 1) denotes a weight (blending ratio), at which each pixel of the image frame “P” is AlphaBlended with the corresponding pixel of the image frame “Q” based on the combination weighting function w[p](x, y). For example, the Alpha-value of each pixel of the image frame “P” giving the least face evaluation value will be the maximum, and if no face is found other than said face, the Alpha-values of the pixels of the image frame will be substantially 1.0 (the Alpha-value of the image frame “Q” will be substantially 1.0). In the case that two objects (two persons) are shot and two image frames are combined, if faces F1, F2 of the two persons are seen substantially at an even distance, Alpha-value at the central point between the two faces F1 and F2 will be substantially 0.5. In the image frame “P” (other image frame “Q”) giving the least face evaluation value, Alpha-value will take a medium value which gradually and continuously increases from 0.5 as a point comes from the medium point to the face F1 (Face F2) of the least face evaluation value on the image frame “P” (other image frame “Q”). Meanwhile, Alpha-value will take a medium value which gradually and continuously decreases from 0.5 as a point comes from the medium point to the face F2 (Face F1) of the other image frame “Q” (image frame “P”).

With respect to pixels of an extremely small weight, which position far from any of faces, a problem can occur that division by zero mathematically occurs and/or that a substantially balanced blending ratios are shown. In this case, the least value which is larger than “0” to some extend is set to the weight of one of the image frames, and a clipping process may be executed to keep the weight from decreasing to not larger than the least value.

The image composing unit 8d blends original image frames “I” using Alpha-value “α” calculated by the blending ratio calculating unit 8e in accordance with the following equation (6) to produce a composed image “R”.

$$r [ x , y ] = {\sum }_{q ∈ U} α [ q ] [ x , y ] * I [ q ] [ x , y ] \qquad ( 6 )$$

More specifically, when combining plural original image frames (for example, image frames “P” and “Q”), the image composing unit 8d allows pixels of Alpha-value “0” of one image frame (for example, image frame “P”) to transmit, and blends pixels of Alpha-value (0<α<1) of the image frame (image frame “P”) with the corresponding pixels of the other original image frame (image frame “Q”), and executes nothing on pixels of Alpha-value “1” of the image frame (image frame “P”) and does not allow the corresponding pixels of the other original image frame (image frame “Q”) to transmit.

The weight altering unit 8c alters the parameter σ[i] and the weight setting unit 8b sets plural combination weighting functions w[p](x, y) of the image frame “P”. Depending on the plural combination weighting functions w[p](x, y), the image composing unit 8d produces plural composed images “R”, in which the pixels of the image frame “P” are overlaid on the corresponding pixels of the image frame “Q” in different overlaying degrees.

The image composing unit 8d serves as image composing means for overlaying the pixels of the image frame “P” on the corresponding pixels of the other image frame “Q” depending on the combination weighting functions w[p](x, y) of the image frame “P” set by the weight setting unit 8b, thereby producing the composed image “R”.

The image processing unit 8 is provided with an image specifying unit 8f for automatically selecting and specifying a composed image “R” having the best edge evaluation value from among the plural composed images of different overlaying degrees produced by the image composing unit 8d.

The image specifying unit 8f is provided with an edge detecting unit 8g for detecting edge points of the plural composed images “R” produced by the image composing unit 8d. The edge detecting unit 8g performs a differential filtering operation of a properly adjusted neighborhood scale and determines the result of the operation based on a predetermined threshold level to extract edges from the composed image “R”, thereby detecting the edge points. Meanwhile, with respect to each edge point detected from the composed image “R”, the edge detecting unit 8g detects an edge from the original image frame, said edge point of which frame has Alpha-value that is larger than or equal to a predetermined value.

The image specifying unit 8f calculates an edge evaluation value J(k) based on the edges of the composed image “R” detected by the edge detecting unit 8g, and specifies the composed image “R” whose edge evaluation value J(k) is least. More specifically, with respect to each edge point of the composed image “R”, when no edge is found in the neighborhood in any of the original image frames whose edge point has Alpha-value that is larger than or equal to a predetermined value, that is, when no edge is found in the original image frame but new and definite edges appear in image combination, the image specifying unit 8f determines the number of such edge points as the edge evaluation value J(k). The image specifying unit 8f performs the above process with respect to all the composed images “R” produced by the image composing unit 8d, and determines that the smaller the edge evaluation value J(k), the better the result, or that the smaller “k” of the edge evaluation value J(k), the better the result, when the edge evaluation value J(k) is in the same range, calculating the optimized value of “k” as the result “k′”. More specifically, the image specifying unit 8f calculates a value of “k”, which minimizes J(k)+λk, where λ is a constant. And the image specifying unit 8f finally outputs k×σ[i] as σ[i].

The recording medium 9 comprises a nonvolatile memory (flash memory) for storing image data or picked-up image data encoded by JPEG compressing unit (not shown) in the image processing unit 8.

The display controlling unit 10 reads the image data temporarily stored in the image memory 5 and controls the displaying unit 11 to display the image data thereon.

The display controlling unit 10 is provided with VRAM (not shown), VRAM controller (not shown) and a digital video encoder (not shown). Under control of CPU 13, the luminance signal “Y” and color-difference signals Cb, Cr are read from the image memory 5 and stored in VRAM. The digital video encoder periodically reads the luminance signal and color-difference signals Cb, Cr from VRAM through the VRAM controller, thereby generating and supplying a video signal to the displaying unit 11.

The displaying unit 11 comprises, for example, a liquid crystal displaying apparatus. The displaying unit 11 displays on its display screen an image picked up by the electronic image pick-up unit 2 based on the video signal sent from the display controlling unit 10. More specifically, the displaying unit 11 displays a Live View Image based on plural image frames produced by shooting an object by means of the lens unit 1, electronic image pick-up unit 2 and the mage pick-up controlling unit 3 in a shooting mode, and displays a Rec View Image or displays an image which a user has just shot.

The operation input unit 12 is used to operate the image pick-up apparatus 100. The operation input unit 12 comprises a shutter button 12a for giving an instruction of shooting an object, a selection button 12b for giving an instruction of selecting the shooting mode, and a zoom button (not shown) for adjusting a zooming operation. The operation input unit 12 sends an operation signal to CPU 13 in response to operation of these buttons.

When the weight altering unit 8c alters the combination weighting function w[p](x, y) in response to user's operation and the image composing unit 8d has produced plural composed images “R”, the user can select the best composed image “R” by operating the selection button 12b. When an instruction signal is supplied to CPU 13 from the selection button 12b, CPU 13 outputs the composed image “R” concerning the instruction signal as the final result. The selection button 12b and CPU 13 serve as image specifying means for specifying any one of the plural composed images “R” produced by the image composing unit 8d.

CPU 13 serves to controls operation of each unit in the image pick-up apparatus 100. CPU 13 performs controlling operations in accordance with various process programs for the image pick-up apparatus 100.

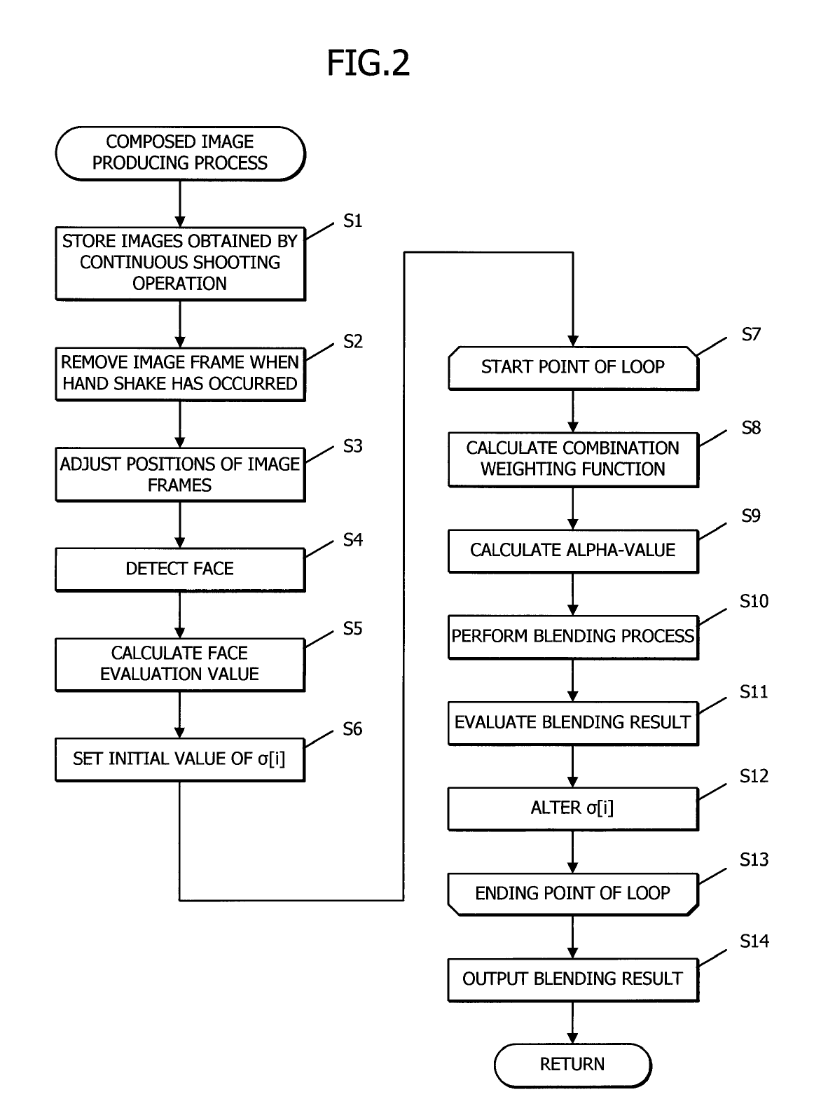

A composed image producing process to be performed in the image pick-up apparatus 100 will be described with reference to FIGS. 2 to 4.

FIG. 2 is a flow chart showing one example of the composed image producing process.

FIGS. 3A and 3B are views schematically showing original image frames used in the composed image producing process. FIG. 4 is a view schematically showing a composed image “R” produced in the composed image producing process.

In FIG. 4, images are indicated in different sorts of lines depending on the blending ratios of the images. For example, a portion (a portion of dog) of Alpha-value of about 0.5 is indicated in thin lines. A portion of Alpha-value of less than 0.5 is indicated in broken lines. For example, a portion of an arm of a lady in the original image frame shown in FIG. 3B is indicated in the broken lines in FIG. 4. A portion of Alpha-value of larger than 0.5 is indicated in solid lines, which is a little thicker than the thin line used to indicate the portion of Alpha-value of about 0.5. For example, a portion of an arm of the lady in the original image frame shown in FIG. 3A is indicated in the solid lines in FIG. 4. An overlapping degree of portions of a dog image is expressed by the number of dots.

The composed image producing process is performed, when the user has operated the selection button 12b of the operation input unit 12 to select an image composing mode out of plural shooting modes displayed on a menu screen.

Group photographs (two persons) are continuously taken, for example, in a park, thereby obtaining images continuously shot and the images continuously shot are stored in the image memory 5 at step S1 in FIG. 2. More specifically, receiving an instruction of a continuous shooting operation in response to user's operation on the shutter button 12a of the input operation unit 12, CPU 13 makes the image pick-up controlling unit 3 adjust a focusing position of the focus lens, exposure conditions (shutter speed, aperture, amplification gain, etc.), and shooting conditions (white balance), and further makes the electronic image pick-up unit 2 continuously generate optical images of an object at a predetermined shooting frame rate (for example, at 10 fps.), thereby performing the continuous shooting operation. Then, CPU 13 makes the image data generating unit 4 produce image data of each image frame of the object based on the optical images sent from the electronic image pick-up unit 2 and temporarily store the image data in the image memory 5.

In the composed image producing process, persons to be included in the group photograph are not limited to two persons but plural persons may be included in the group photograph.

CPU 13 makes the position adjusting unit 6 perform a prior processing for detecting attenuation of high frequency components of each original image frame to judge whether or not hand shake has occurred while generating said image frame, and further makes the position adjusting unit 6 remove the image frame if it determined that hand shake has occurred while generating said image frame, thereby improving sharpness of the composed image at step S2. Then, CPU 13 makes the position adjusting unit 6 adjust positions of plural image frames without the image frames removed because of hand shake at step S3.

More specifically, the feature value calculating unit of the position adjusting unit 6 unit selects a predetermined number of block areas (feature points) containing prominent features, from one (for example, image frame “P”) of the image frames based on YUV data of said image frame (image frame “P”), and extracts contents of the selected block areas to produce templates. The block matching unit searches in the adjacent image frame for the position which best meets with the pixel value of the template extracted and produced in the feature extracting process, and calculates the most suitable offset or disagreement between the adjacent image frames where the most appropriate evaluation value of differences of the pixel values is given to obtain the motion vector of the template. The coordinate-transform equation calculating unit statistically calculates the whole motion vector based on the motion vectors of the plural templates calculated by the block matching unit, and calculates a projection transform matrix of the other image frame using the feature point correspondence concerning the whole motion vector. The position adjusting unit 6 transforms the coordinate of the other image frame in accordance with the calculated projection transform matrix, thereby adjusting the position of the other image frame so as to bring both the image frames in position. The image frame which has been subjected to the position adjustment is expressed by i[p].

The position adjustment of the image frames (step S3) and processes to be performed thereafter can be performed on image frames which are reduced in size, and further the calculation amount can be decreased according to need.

CPU 13 makes the face detecting unit 7 detect a human face from each image frame produced in the continuous shooting operation by the image pick-up means using the predetermined human face detecting method, and further makes the face detecting unit 7 detect a face image area (face frame) from the image frame to obtain a position and size of a face at step S4.

Further, CPU 13 makes the evaluation value calculating unit 8a of the image processing unit 8 calculate the evaluation value of a face of each image frame, using evaluation of the blinking rate of a human eye, evaluation of a smile on a face including narrowed eye look and look of mouth corner, and total evaluation of these evaluations, wherein good looks is given the evaluation value of a less value (step S5).

The evaluation value calculating unit 8a selects one of the plural image frames, in which a person “i” (face frame) giving the least evaluation value is seen. The frame index of such image frame is denoted by b[i].

Then, CPU 13 makes the weight setting unit 8b of the image processing unit 8 set a product of the size s[i] of the face frame and a proper constant, that is, a value proportional to the size s[i] of the face frame to the initial value of the parameter σ[i] at step S6. Further, CPU 13 makes the image processing unit 8 perform a loop process (steps S7 to S13) to produce a composed image “R” from plural image frames.

More specifically, in the case plural image frames are combined to produce a composed image, the weight setting unit 8b of the image processing unit 8 defines the combination weighting function w[p](x, y) of one of the plural image frames to the other image frame by Gaussian function expressed in the following equation (1), and calculates the combination weighting function w[p](x, y) for pixel (x, y) of each image frame “p” with respect to every person “i” of p=b[i] in each image frame “p” in accordance with the following equation (2) at step S8.

$$\begin{matrix}f [ i ] ( x , y ) = exp ( - \frac{{( u [ i ] - x )}^{2} + {( v [ i ] - y )}^{2}}{2 {σ [ i ]}^{2}} ) & ( 1 ) \\ w [ p ] ( x , y ) = {max}_{i ∈ \{ i \vert p = b [ i ] \}} f [ i ] ( x , y ) & ( 2 )\end{matrix}$$

Then, the blending ratio calculating unit 8e calculates an Alpha-value (blending ratio) of each pixel of the one image frame (image frame “P”) to the corresponding pixel of the other image frame (image frame “Q”) based on the combination weighting function w[p](x, y), using the following equation (5) at step S9.

$$α [ p ] [ x , y ] = \frac{w [ p ] ( x , y )}{{\sum }_{q ∈ U} w [ q ] ( x , y )} \qquad ( 5 )$$

The image composing unit 8d of the image composing unit 8 performs a blending process using the original image frames “I” and Alpha-value “α” calculated by the blending ratio calculating unit 8e in accordance with the following equation (6) at step S10, thereby producing a composed image “R”.

$$r [ x , y ] = {\sum }_{q ∈ U} α [ q ] [ x , y ] * I [ q ] [ x , y ] \qquad ( 6 )$$

More specifically, the image composing unit 8d combines pixels of the one image frame (for example, image frame “P”) with the corresponding pixels of the other image frame (for example, image frame “Q”) to produce a composed image “R”, as described below. That is, the image composing unit 8d allows pixels of Alpha-value “0” of one (for example, image frame “P”) of the original image frames to transmit. In other words, the image composing unit 8d puts the corresponding pixels of the other image frame (for example, image frame “Q”) on such pixels of the image frame “P”. Further, the image composing unit 8d blends pixels of Alpha-value (0<α<1) with the corresponding pixels of the other original image frame (for example, image frame “Q”), and executes nothing on pixels of Alpha-value “1” and does not allow the corresponding pixels of the other original image frame (image frame “Q”) to transmit. In this way, the composed image “R” is produced.

Then, blending result of the composed image “R” produced in the blending process is evaluated at step S11. In the following description, the image specifying unit 8f automatically evaluates the blending result of the composed image “R” produced in the blending process on the assumption that a mode has been set, in which the overlapping degree is automatically altered.

The edge detecting unit 8g of the image specifying unit 8f extracts edges of the composed image produced by the image composing unit 8d to detect edge points. Then, with respect to each edge point of the composed image “R”, when no edge is found in the neighborhood in any of the original image frames whose edge point has Alpha-value that is larger than or equal to a predetermined value, that is, when no edge is found in the original image frame but new and definite edges appear in image combination, the image specifying unit 8f of the image specifying unit 8f determines the number of such edge points as the edge evaluation value J(k). The edge evaluation value J(k) of each composed image “R” is temporarily stored in the image memory 5. The image specifying unit 8f performs the above process with respect to all the composed images “R” produced by the image composing unit 8d.

Then, the weight altering unit 8c of the image processing unit 8 automatically alters the scale of σ value from a small value to a large value (for example, 0.5 to 1.5) at step S12. Then, CPU 13 returns to step S8, and makes the weight setting unit 8b calculate the combination weighting function w[p](x, y) using the parameter σ[i] altered by the weight altering unit 8c. Further, CPU 13 makes the image composing unit 8d perform the blending process using Alpha-value calculated by the blending ratio calculating unit 8e and each original image frame “I” to produce a composed image “R”.

The above described process is repeatedly performed every time when the parameter σ[i] is altered at step S12, and the blending result of the composed image “R” newly produced in the blending process at step S11, whereby the image specifying unit 8f determines that the smaller the edge evaluation values J(k) temporarily stored in the image memory 5, the better the result, or that the smaller “k” of the edge evaluation value J(k), the better the result, when the edge evaluation value J(k) is in the same range, calculating the optimized value of “k” as the result “k′”.

The image specifying unit 8f finally outputs k×σ[i] as σ[i], finishing the composed image producing process at step S14.

As described above, the image blending process is performed based on the optimized combination weighting function w[p](x, y) to overlay the pixels of the one image frame (image frame “P”, FIG. 3A) on the corresponding pixels of the other image frame (image frame “Q”, FIG. 3B), respectively, thereby producing the composed image “R” (FIG. 4).

In the image pick-up apparatus 100 according to the embodiment of the invention, the combination weighting function w[p](x, y) is set such that, on the basis of a face of a person seen in at lease one (image frame “P”) of the two image frames (for example, image frames “P” and “Q”), combination weights of the pixels of the image frame “P” to the corresponding pixel of the image frame “Q” are set, which decrease with increasing distance from the face of the person seen in the image frame “P”. The pixels of the one image frame (image frame “P”) are overlaid on the corresponding pixels of the other image frame (image frame “Q”) in accordance with the combination weighting function w[p](x, y) of the image frame “P”, whereby the composed image “R” is produced.

As described above, the combination weighting function w[p](x, y) can be adjusted with use of one parameter σ[i] for everyone image frame or with use of one parameter σ[i] for every person. Therefore, since the user is not requested to input many coordinates as required in a conventional interactive operation system, a composed image “R” can be produced in a simple manner.

Further, a spatially and continuously altering function, which is inversely-correlated with distance from the center of face, is used as Alpha-value to blend plural image frames. Therefore, when a person moves while the image frames “P” and “Q” are being produced, the person appears double in the composed image “R” of the image frames “P and “Q”. Such composed image “R” can be acceptable when a picture is taken under a long exposure time to express motion therein. That is, even if a scene includes essential unconformity, since the scene covers a wide area which can be adjusted by the parameter but appears at a portion other than a human face (feature point), the scene is seen double in the composed image “R” and showing natural motion blur effect. Therefore, the user feels no sense of discomfort while watching such composed image “R”.

A composed image of a person can be properly produced with his or her face in focus and other portion brought out of focus as increasing distance from the face of the person.

Based on the plural combination weighting functions w[p](x, y), plural composed images “R” are produced, in which the pixels of the image frame “P” are overlaid on the corresponding pixels of the other image frame “Q” in different overlaying degrees. Edges are detected from the plural composed images “R” of different overlaying degrees. Then, the composed image “R” having the best edge evaluation value is selected and specified from among the plural composed images “R” of different overlaying degrees. Sharpness in change caused in the composed image “R” is expressed by a parameter σ[i], and the best result can be achieved by adjusting the parameter σ[i].

Since plural combination weighting functions w[p](x, y) of the pixels of the one image frame “P” to the corresponding pixels of the other image frame “Q” can be automatically set by altering the parameter σ[i], the most appropriate composed image can be produced in a simple manner.

In the case the user operates the operation input unit 12 to adjust the parameter σ[i], the user can adjust the parameter σ[i] by operating a simple button and is not required to input many coordinates as requested in the conventional interactive operation system, and can produce a composed image “R” in a simple manner.

It should be understood that the invention is not limited to the particular embodiments described above, but numerous rearrangements, modifications, and substitutions may be made to the described embodiments without departing from the scope of the invention.

For example, one image frame, in which a person shows the least face evaluation value is specified in the above embodiments, but plural image frames, in which a person shows a face evaluation value that is lower than a predetermined threshold value maybe specified as image frames to be combined. In this case, since a combination of persons to be combined is given by a permutation, the persons can be combined in various ways. In the area where Alpha-values are balanced, sum of difference levels of pixels and gradient between the original image frames is calculated, and the least difference level is chosen, whereby the combination of persons, which shows least unconformity can be selected. In this way, the combination of persons can be optimized, reducing the possibility of inviting unconformity and enhancing utility of the present invention.

In the embodiments described herein, the human face is exemplified as the feature point of a person, but any portion showing features can be used as the feature point. The feature point can be divided into an area which should be focused on and an area which is allowed to be blur.

The configuration of the image pick-up apparatus 100 described herein is an example, and the image pick-up apparatus 100 can have another configuration. In the embodiment of the invention, the image pick-up apparatus 100 is used as the image composing apparatus, but it is possible to use an image pick-up apparatus other than the image pick-up apparatus 100 to perform the continuous shooting operation, and to record only image data sent from the image pick-up apparatus, thereby performing the composed image producing process.

In the embodiments of the invention, under control of CPU 13, the electronic image pick-up unit 2 and the mage pick-up controlling unit 3 serve as the image pick-up means, the face detecting unit 7 serves as the feature detecting means, the weight setting unit 8b serves as the weight setting means, and the image composing unit 8d serves as the image composing means. But the functions of the respective means will be realized by CPU 13 running predetermined programs.

In a program memory (not shown) is recorded a program including an image pick-up routine, feature detecting routine, weight setting unit routine, and an image composing routine. CPU 13 reads and runs the program to execute the image pick-up routine, feature detecting routine, weight setting unit routine, and the image composing routine. In the image pick-up routine, plural persons are continuously shot, whereby at least two image frames “P” and “Q” are produced. And a position of a feature point of a person is detected from each of the image frames “P” and “Q” in the feature detecting routine. In the weight setting routine, based on the detected feature point of one (image frame “P”) of the image frames “P” and “Q”, combination weights of the pixels of the image frames “P” to the corresponding pixels of the image frame “Q” are set, which decrease with increasing distance from the feature point of the image frame “P”. Further, in the image composing routine, the pixels of the image frame “P”, on which the combination weights have been set, are overlaid on the corresponding pixels of the image frame “Q”, whereby the composed image “R” is produced.

What is claimed is:

1. An image composing apparatus comprising:
an image pick-up unit for continuously taking group photographs with the same background to produce at least two images, wherein the group photograph includes plural persons;
a feature detecting unit for detecting a position of a feature portion of each person included in the group photograph from each of the two images produced by the image pick-up unit;
a weight setting unit for, on the basis of the position of the feature portion in one of the two images detected by the feature detecting unit, setting combination weights of pixels of said one image to corresponding pixels of the other image, which combination weights decrease with increasing distance from the position of the feature portion in said one image; and
an image composing unit for overlaying the pixels of said one image on the corresponding pixels of the other image in accordance with the combination weights of said one image set by the weight setting unit to produce a composed image.

2. The image composing apparatus according to claim 1, wherein
the weight setting unit sets plural sets of combination weights of said one image to the other images;
the image composing unit overlays the pixels of said one image on the corresponding pixels of the other images in accordance with the plural sets of combination weights set by the weight setting unit, thereby producing plural composed images of different overlaying degrees, and
the image composing apparatus further comprising:
an edge detecting unit for detecting edges from the plural composed images produced by the image composing unit; and
an image specifying unit for specifying among the plural composed images one composed image, in which the edge of the best evaluation value is detected by the edge detecting unit.

3. The image composing apparatus according to claim 2, wherein
the weight setting unit alters the combination weights of the pixels of said one image to the corresponding pixels of the other image, and automatically sets plural sets of combination weights of the pixels of said one image to the corresponding pixels of the other image.

4. The image composing apparatus according to claim 1, wherein
the weight setting unit sets plural sets of combination weights of pixels of said one image to the corresponding pixels of the other image, based on instructions given in accordance with user's operation;
the image composing unit overlays the pixels of said one image on the corresponding pixels of the other image in accordance with the plural sets of combination weights set by the weight setting unit, thereby producing plural composed images of different overlapping degrees; and
the image composing apparatus further comprising:
an image designating unit for designating one of the plural composed image produced by the image composing unit in response to user's operation.

5. The image composing apparatus according to claim 1, wherein
the feature detecting unit includes a face detecting unit for detecting a position of a face of a person from each of the images produced by the image pick-up unit.

6. A computer readable recording medium to be mounted on an image composing apparatus, wherein the image composing apparatus is provided with a computer and an image pick-up unit for continuously taking group photographs with the same background to produce at least two images, wherein the group photograph includes plural persons, the recording medium having recorded thereon a computer program when executed to make the computer function as means comprising:
a feature detecting means for detecting a position of a feature portion of each person included in the group photograph from each of the two images produced by the image pick-up unit;
a weight setting means for, on the basis of the position of the feature portion detected in one of the two images by the feature detecting means, setting combination weights of pixels of said one image to corresponding pixels of the other image, which combination weights decrease with increasing distance from the position of the feature portion in said one image; and
an image composing means for overlaying the pixels of said one image on the corresponding pixels of the other image in accordance with the combination weights set by the weight setting means to produce a composed image.
